(19) United States
(12) Patent Application Publication
(10) Pub. No.: US 2011/0206329 A1
(43) Pub. Date: Aug. 25, 2011

(54) FIBER TERMINAL BOX

(76) Inventor: Liming Wang, Shanghai (CN)

(21) Appl. No.: 13/126,661

(22) PCT Filed: Oct. 21, 2009
(86) PCT No.: PCT/IB09/54640

§ 371 Date: Apr. 28, 2011

(30) Foreign Application Priority Data
Oct. 28, 2008 (CN) 200810202060.6

(51) Int. Cl. G02B 6/46; G02B 6/255

(52) U.S. Cl. 385/96; 385/95; 385/135

(57) ABSTRACT

Disclosed is a fiber terminal box comprising: a panel having a front surface and a rear surface; a front cover for covering the front surface of the panel; and a case adapted to be embedded in a wall. An adapter and a fiber splicing member are mounted on the front surface of the panel, and the panel is adapted to be accommodated in the case and hence be embedded in the wall along with the case. The panel is provided with an optical cable inserting hole through which a lead-in end of an optical cable is led from the rear surface of the panel to the front surface of the panel and is connected to one end of the fiber splicing member. The panel is further provided with a fiber pigtail hole, one end of a fiber pigtail is connected to the terminal of the adapter, the other end of the fiber pigtail is led from the rear surface of the panel to the front surface of the panel through the fiber pigtail hole and is connected to the other end of the fiber splicing member. As the fiber terminal box of the present invention can be embedded in the wall along with the case, the fiber terminal box can be easily mounted and can be in harmony with other panels in house. In addition, since fiber devices, such as the adapter and the fiber splicing member, are all mounted on the front surface of the panel, the operation and management of the fibers become easier than in the prior art.

### CROSS-REFERENCE TO RELATED APPLICATION

This application claims the benefit of Chinese Patent Application No. 200810202060.6 filed on Oct. 28, 2008 in the State Intellectual Property Office of China, the disclosure of which is incorporated herein by reference.

### BACKGROUND OF THE INVENTION

1. Field of the Invention

The present invention relates to a fiber terminal box on the user's end for distributing an optical cable to a house.

2. Description of the Related Art

It has been known in the prior art that a fiber terminal box is often directly mounted on an outside surface of a wall and is projected from the outside surface of the wall. As a result, from aesthetic aspect, the fiber terminal box is not in harmony with other panels in house, such as panels for a power source and panels for a net. Furthermore, the fiber terminal box in prior art is very poor in the capacity to manage the fiber, difficult to be mounted, and re-installment of it after having been mounted is almost impossible to be implemented.

### SUMMARY OF THE INVENTION

The present invention has been made to overcome or alleviate at least one aspect of the above mentioned disadvantages.

Accordingly, it is an object of the present invention to provide a fiber terminal box for which the mounting operations can be easily carried out and the management of the fibers are improved.

According to an aspect of the present invention, there is provided a fiber terminal box, comprising: a panel having a front surface and a rear surface; a front cover for covering the front surface of the panel; and a case adapted to embedded in a wall, wherein an adapter and a fiber splicing member are mounted on the front surface of the panel; the panel is adapted to be accommodated in the case and embedded in the wall along with the case; the panel is provided with an optical cable inserting hole through which a lead-in end of an optical cable is led from the rear surface of the panel to the front surface of the panel and is connected to one end of the fiber splicing member; and the panel is further provided with a fiber pigtail hole, one end of the fiber pigtail is connected to the terminal of the adapter, the other end of the fiber pigtail is led from the rear surface of the panel to the front surface of the panel through the fiber pigtail hole and is connected to the other end of the fiber splicing member.

Preferably, the panel is connected to the case by screws. More preferably, the panel is provided with mounting holes; the case is provided therein with protruding mounting pillars; and the screws are inserted through the mounting holes of the panel and are fixed to the protuberant mounting pillars of the case.

More preferably, the fiber terminal box further comprises a rear cover for covering the rear surface of the panel. More preferably, the rear cover has a protruding engagement portion thereon; the rear surface of the panel extends outwards to form a projection that is configured to form a concave engagement portion corresponding to the protruding engagement portion; and when the protruding engagement portion engages with the concave engagement portion, the rear cover is brought into engagement with the panel.

More preferably, the fiber splicing member includes: a fusion splicer or a mechanical splicer; and an affixing device for fixing the fusion splicer or the mechanical splicer.

More preferably, an optical cable fastening device is provided on the front surface of the panel to fasten the optical cable on the front surface of the panel.

More preferably, the fiber pigtail is wound with one or more turns on the front surface of the panel.

More preferably, when the fiber terminal box is mounted into the wall, the outside surface of the front cover of the fiber terminal box is in flush with the outside surface of the wall or is slightly projected beyond the outside surface of the wall.

As the fiber terminal box of the present invention can be embedded in the wall by the case, the fiber terminal box can be easily mounted and be in harmony with other household panels. In addition, since fiber devices, such as the adapter and the fiber splicing member, are all mounted on the front surface of the panel, the management of the fibers become easier than in the prior art.

### BRIEF DESCRIPTION OF THE DRAWINGS

FIG. 1 is a perspective exploded schematic view of a fiber terminal box according to an embodiment of the present invention;

FIG. 2 is a front view of a panel of the fiber terminal box shown in FIG. 1, showing a route of the fiber; and

FIG. 3 is an enlarged view showing a state in which a fiber pigtail is connected to a terminal of an adapter.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

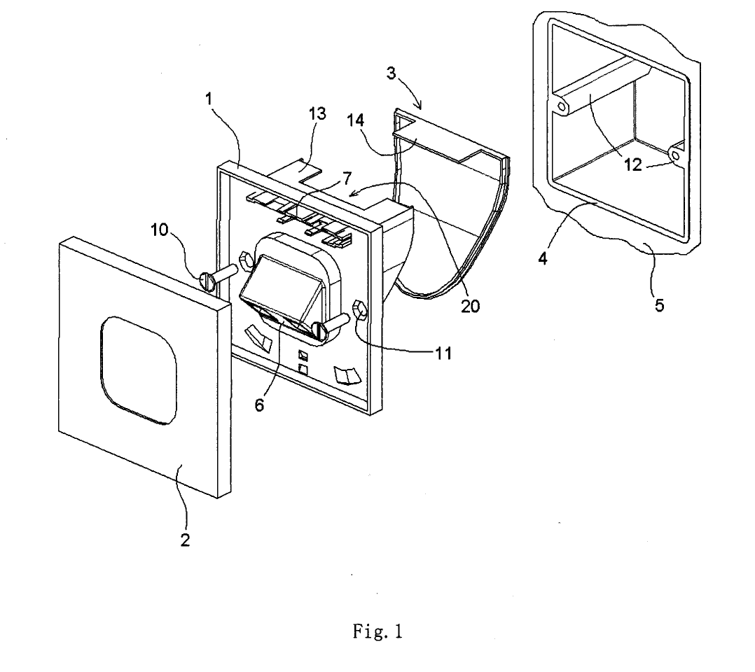

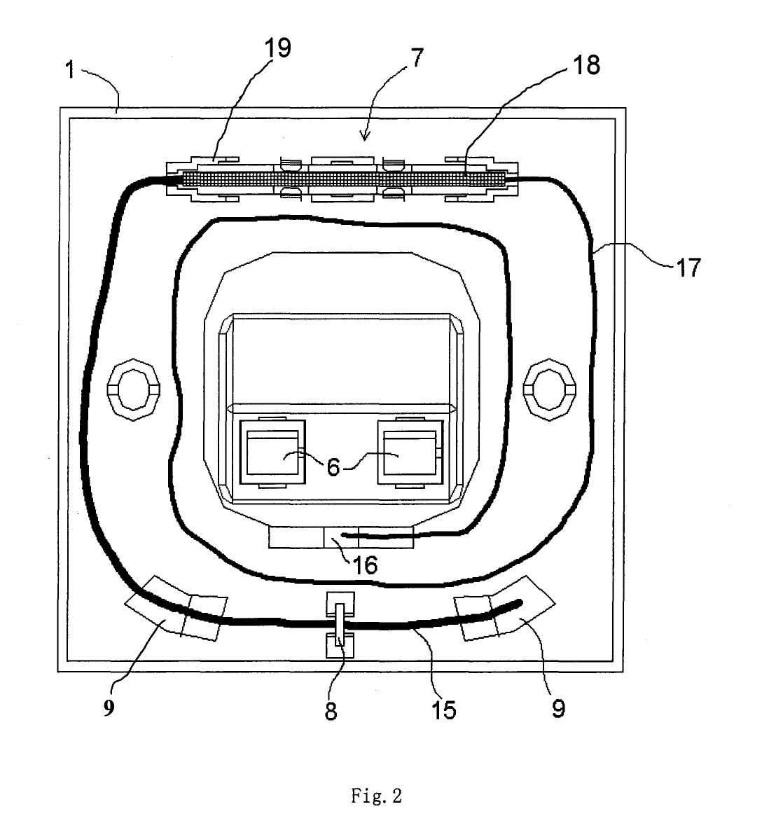

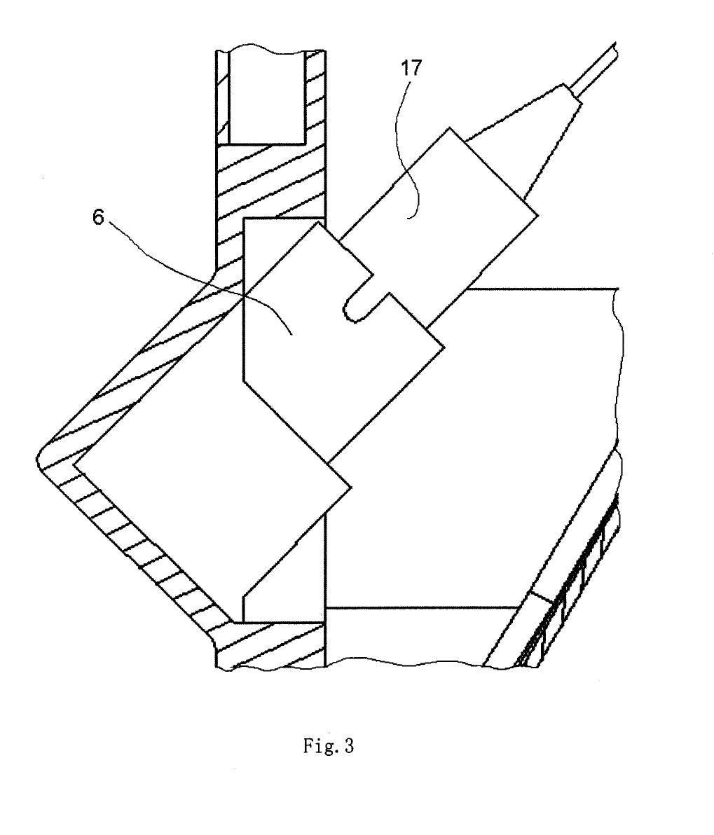

FIGS. 1-3 show an embodiment of the fiber terminal box of the present invention. Particularly, FIG. 1 is a perspective exploded schematic view of a fiber terminal box according to an embodiment of the present invention; FIG. 2 is a front view of a panel of the fiber terminal box shown in FIG. 1, showing a route of the fiber; and FIG. 3 is an enlarged view showing a state in which a fiber pigtail is connected to a terminal of an adapter.

As shown in FIG. 1, in this embodiment, the fiber terminal box comprises a panel 1, a front cover 2, a rear cover 3 and a case 4 adapted to be embedded in a wall 5. The panel 1 has a front surface and a rear surface. The front cover 2 is used to cover the front surface of the panel 1. The rear cover 3 is used to cover the rear surface of the panel 1. It should be noted that the rear cover 3 is not necessary and may be omitted.

Particularly, referring to FIGS. 1-2, an adapter 6 and a fiber splicing member 7 are both mounted on the front surface of the panel 1. The panel 1 may be accommodated in the case 4 and can be embedded in the wall 5 along with the case 4.

In a particular embodiment, as shown in FIG. 2, the panel 1 is provided with an optical cable inserting hole 9. A lead-in end of an optical cable 15 is led from the rear surface of the panel 1 to the front surface of the panel 1 through the optical cable inserting hole 9 and is connected to one end of the fiber splicing member 7.

In a particular embodiment, as shown in FIGS. 2 and 3, the panel 1 is further provided with a fiber pigtail hole 16. Referring to FIG. 3, one end of a fiber pigtail 17 is connected to the terminal of the adapter 6, and the other end of the fiber pigtail 17 is led from the rear surface of the panel 1 to the front surface of the panel 1 through the fiber pigtail hole 16 and is connected to the other end of the fiber splicing member 7.

According to a preferred example, both the adapter 6 and the fiber pigtail 17 may be mounted on the panel 1 in advance, instead of being mounted on site. As a result, the efficiency and convenience of mounting the fiber terminal box can be greatly improved.

More particularly, as shown in FIG. 1, the panel 1 is provided with two mounting holes 11. The case 4 is formed with two protruding mounting pillars 12. Two screws 10 are inserted through the mounting holes 11 of the panel 1 and are fixed to the protuberant mounting pillars 12 of the case 4. In this way, the panel 1 may be mounted in the case 4. It should be noted that, although, in the present embodiment, the panel 1 and the case 4 are connected by screws, however, the present invention is not limited to this, they can be connected by other connecting means, such as in a snap-fit way or by fasteners.

In a preferred example, referring to FIG. 1, the rear cover 3 is formed with a protruding engagement portion 14 thereon. The rear surface of the panel 1 extends outwards to form a projection 13. The projection 13 is configured to form a concave engagement portion 20 corresponding to the protruding engagement portion 14. Once the protruding engagement portion 14 engages with the concave engagement portion 20, the rear cover 3 is brought into engagement with the panel 1. It should be noted that the present invention is not limited to this, the rear cover 3 may engage with the panel in other ways, such as by screws or by rivets.

Further, as shown in FIG. 2, the fiber splicing member 7 includes: a fusion splicer or a mechanical splicer 18; and an affixing device 19 for fixing the fusion splicer or the mechanical splicer 18.

Furthermore, an optical cable fastening device 8 is provided on the front surface of the panel 1 to tightly fasten the optical cable 15 on the front surface of the panel 1.

Moreover, the fiber pigtail 17 is wound with one or more turns on the front surface of the panel 1 so as to form a predetermined length of slack or redundant fiber, which on one hand could protect the fiber pigtail from being over stretched during operation, thereby facilitating the subsequent installation operations of the fiber terminal box.

In an exemplified embodiment, when the fiber terminal box is mounted into the wall 5 along with the case 4, the outside surface of the front cover 2 of the fiber terminal box is in flush with the outside surface of the wall 5 or is slightly projected beyond the outside surface of the wall 5. In this way, the fiber terminal box can be in good harmony with other panels in house, such as panels for a power source and panels for a network.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A fiber terminal box comprising:
a) a panel having a front surface and a rear surface;
b) a front cover for covering the front surface of the panel; and
c) a case adapted to be embedded in a wall, wherein
d) an adapter and a fiber splicing member are mounted on the front surface of the panel,
e) the panel is adapted to be accommodated in the case and embedded in the wall along with the case;
f) the panel is provided with an optical cable inserting hole through which a lead-in end of an optical cable is led from the rear surface of the panel to the front surface of the panel and is connected to one end of the fiber splicing member, and
g) the panel is further provided with a fiber pigtail hole, one end of a fiber pigtail is connected to a terminal of the adapter, the other end of the fiber pigtail is led from the rear surface of the panel to the front surface of the panel through the fiber pigtail hole and is connected to the other end of the fiber splicing member.

2. The fiber terminal box according to claim 1, wherein the panel is connected to the case by screws.

3. The fiber terminal box according to claim 2, wherein
a) the panel is provided with mounting holes,
b) the case is provided with a protruding mounting pillars, and
c) the screws are inserted through the mounting holes of the panel and are fixed to the protuberant mounting pillars of the case.

4. The fiber terminal box according to claim 1, further comprising a rear cover for covering the rear surface of the panel.

5. The fiber terminal box according to claim 4, wherein
a) the rear cover has a protruding engagement portion thereon,
b) the rear surface of the panel extends outwards to form a projection which is configured to form a concave engagement portion corresponding to the protruding engagement portion, and
c) when the protruding engagement portion engages with the concave engagement portion, the rear cover is brought into engagement with the panel.

6. The fiber terminal box according to claim 1, wherein the fiber splicing member includes:
a) a fusion splicer or a mechanical splicer; and
b) an affixing device for fixing the fusion splicer or the mechanical splicer.

7. The fiber terminal box according to claim 1, wherein an optical cable fastening device is provided on the front surface of the panel to fasten the optical cable on the front surface of the panel.

8. The fiber terminal box according to claim 1, wherein the fiber pigtail is wound with one or more turns on the front surface of the panel.

9. The fiber terminal box according to claim 1, wherein when the fiber terminal box is mounted into the wall, the outside surface of the front cover of the fiber terminal box is in flush with the outside surface of the wall or is slightly projected beyond the outside surface of the wall.

10. The fiber terminal box according to claim 1, wherein the adapter and the fiber pigtail are both mounted on the panel in advance.
